(19) United States
(12) Patent Application Publication
(10) Pub. No.: US 2019/0118519 A1
(43) Pub. Date: Apr. 25, 2019

(54) ELASTOMER SANDWICH SYSTEMS AND METAL COMPOSITE ELEMENTS

(71) Applicant: Covestro Deutschland AG, Leverkusen (DE)

(72) Inventors: Andreas STUMPF, Guilherand (FR); Jürgen HÄTTIG, Odenthal (DE); Slaven GOJSIC, Zagreb (HR); Antonio ALVAREZ, Chantemerle les Bles (FR)

(73) Assignee: Covestro Deutschland AG, Leverkusen (DE)

(21) Appl. No.: 16/096,764

(22) PCT Filed: Apr. 27, 2017
(86) PCT No.: PCT/EP2017/060090

§ 371 Date: Oct. 26, 2018

(30) Foreign Application Priority Data
Apr. 28, 2016 (EP) 16305495.0

(51) Int. Cl. B32B 27/40; B32B 15/095; B32B 27/08; B32B 7/12

(52) U.S. Cl. CPC B32B 27/40; B32B 15/095; B32B 27/08; B32B 7/12; B32B 2250/03; B65G 15/32; B32B 2413/00; B32B 2307/536; B32B 2307/54; B32B 2307/554; B32B 2307/51; B32B 2250/40

(57) ABSTRACT

The invention relates to elastomer sandwich systems containing at least two components, wherein one component is (i) a thermoplastic polyurethane functioning as a cover layer and, adhering thereto over its area, the second component is (ii) a noncellular cast polyurethane having a density of from 800 to 1800 kg/m³ functioning as a carrier layer, wherein at least one component of the elastomer sandwich system has a tear propagation resistance in accordance with ISO 34-1 of from 30 kN/m to 85 kN/m and an abrasion loss in accordance with ISO 4649 of from 50 mm³ to 5 mm³ and in addition at least the two components have a rebound resilience in accordance with DIN 53512 of 35%-70%, and a process for the production thereof. The invention further relates to metal composite elements containing elastomer sandwich systems, a process for the production thereof and the use thereof as lining elements in the transport sector and mining and mine sector, in particular in hoppers and conveyor belts. Elastomer sandwich systems can also be used as protection for loading floors of trucks.

The invention relates to elastomer sandwich systems containing at least two components, wherein one component is (i) a thermoplastic polyurethane and, adhering thereto over its area, the second component is (ii) a noncellular cast polyurethane having a density of from 800 to 1800 kg/m³, wherein at least one component of the elastomer sandwich system has a tear propagation resistance in accordance with ISO 34-1 of from 30 kN/m to 85 kN/m and an abrasion loss in accordance with ISO 4649 of from 50 mm³ to 5 mm³ and in addition at least the two components have a rebound resilience in accordance with DIN 53512 of 35%-70%, and a process for the production thereof. Component (i) functions as a cover layer showing tear propagation resistance while the second component (ii) functions as an energy absorbing carrier layer. The invention further relates to metal composite elements containing elastomer sandwich systems, a process for the production thereof and the use thereof as lining elements in the transport sector and mining and mine sector, in particular in hoppers and conveyor belts.

Composite elements based on metals and rubber, generally also spoken of as “metal-rubber composites”, are generally known. They are widely used in, for example, the mining sector in various applications such as hoppers or conveyor belts.

U.S. Pat. No. 9,126,762 describes the use of rubber as covering and protective layer for the metal support in these applications. The advantages of rubber are the excellent tear propagation resistance. Disadvantages of rubber are the costly production, the low rebound resilience of <30% and the high abrasion of >80 mm³, which shortens the life in the corresponding applications and is undesirable for economic reasons.

EP-A2 1 013 416 describes composite elements containing thermoplastic polyurethanes and microcellular polyurethane elastomers with a density between 300 to 7000 kg/m³, a tensile strength of from 3 to 8 N/mm² according to DIN 53571, an elongation at rupture of from 350 to 550% according to DIN 53571, a tear propagation resistance of from 8 to 30 N/mm according to DIN 53515 and a rebound resilience of from 50 to 60% according to DIN 53512 as damping elements in vehicle construction. However, disadvantages of the microcellular layers and the resulting composite system are the low energy absorption which, in the case of the requirement profile in mining, would result in a significantly greater required layer thickness, which would have an adverse effect on the throughputs of existing hopper geometries, and the low level of mechanical properties compared to noncellular polyurethane elastomers with a density of >800 kg/m³, which largely rules out suitability in mining.

Also known are composite elements of reinforcing fabric and polyurethane cast elastomers with an additional layer of thermoplastic polyurethane of up to 1 mm thickness between the two layers a s described in EP-A2 0 280 175. The layer made of thermoplastic polyurethane functions as an immersing layer of the reinforcing fabric as well as a shock absorbing layer. These composite elements are used for the manufacturing of horizontally running endless belts. There are no information on the mechanics.

Cast elastomers based on cast polyurethanes (CPU) are therefore used as rubber substitute in various applications in mining, these being inexpensive to produce and not having the abovementioned disadvantages of rubber such as high abrasion and low rebound resilience. With CPUs abrasion values of <30 mm³ are obtained, the rebound resilience lies at >50%. However, cast polyurethanes have the disadvantage of a tear propagation resistance which is lower than that of rubber. While high performance rubbers show values of >60 N/mm, the level for cast polyurethane is at 25 to 40 N/mm depending on the Shore A hardness.

It is therefore an object of the present invention to develop a material concept which overcomes the abovementioned disadvantages.

This object has been able to be surprisingly achieved by the development of elastomer sandwich systems containing at least two components, wherein one component is

(i) a thermoplastic polyurethane functioning as a cover layer and, adhering thereto over its area, the second component is

(ii) a noncellular cast polyurethane having a density of from 800 to 1800 kg/m³ functioning as a carrier layer,

characterized in that the at least one cover layer component of the elastomer sandwich system has a tear propagation resistance in accordance with ISO 34-1 of from 30 kN/m to 85 kN/m and an abrasion loss in accordance with ISO 4649 of from 50 mm³ to 5 mm³ and in addition at least the two components have a rebound resilience in accordance with DIN 53512 of 35%-70%.

In one embodiment of the invention, the elastomer sandwich system can be a layer composite in which at least one thermoplastic polyurethane layer is joined to at least one noncellular cast polyurethane layer. Here, the elastomer sandwich systems of the invention can consist of a thermoplastic polyurethane (TPU) covering layer and a support layer composed of a cast polyurethane (CPU). The requirement profile for the covering layer, e.g. excellent tear propagation resistance and rebound resilience and also low abrasion, and the requirement profile for the CPU support layer, e.g. high energy absorption (as shock absorber-material is not punctured) and high rebound resilience (pointed object is, for example, sprung back), are satisfied by this material concept.

Owing to the different requirement profile for the two layers, TPU and CPU having different Shore A hardnesses are used. In the case of the TPU, Shore A hardnesses of from at least 75 to 95 Shore A are preferred, in particular from 80 to 90 Shore A, very particularly preferably from 82 to 87 Shore A. The Shore A hardness of the CPU layer is in the range from 50 to 85 Shore A, preferably from 55 to 75 Shore A and particularly preferably in the range 60-70 Shore A.

In addition, the TPU layer has a tear propagation resistance in accordance with ISO 34-1 of from 30 kN/m to 85 kN/m, preferably from 50 kN/m to 75 kN/m, particularly preferably from 60 kN/m to 70 kN/m.

Furthermore, the TPU layer displays an abrasion loss in accordance with ISO 4649 of from 50 mm³ to 5 mm³, preferably from 45 mm³ to 7 mm³, particularly preferably from 35 mm³ to 10 mm³.

In addition, the TPU layer has a rebound resilience which corresponds to that of the CPU or else is at least very similar.

The layer thickness of the TPU layer is normally between 1, 5 and 25 mm, preferably 2 and 15 mm, especially preferred 2-10 mm.

In one embodiment of the invention, the elastomer sandwich system can be a thermoplastic polyurethane (i)—noncellular cast polyurethane (ii) layer composite, a thermoplastic polyurethane (i)—noncellular cast polyurethane (ii)—thermoplastic polyurethane (i) layer composite or a thermoplastic polyurethane (i)—noncellular cast polyurethane (ii)—thermoplastic polyurethane (i)—noncellular cast polyurethane (ii) layer composite, preferably a thermoplastic polyurethane (i)—noncellular cast polyurethane (ii) layer composite.

The elastomer sandwich systems can be produced in various ways.

The invention therefore likewise provides a process for producing elastomer sandwich systems, wherein these are produced by

a) production of thermoplastic polyurethane (i) and

b) subsequent attachment of noncellular cast polyurethane (ii).

In a first step, the thermoplastic polyurethane layer (TPU) is produced. In the second step, the noncellular cast polyurethane (CPU) is produced.

Here, the noncellular cast polyurethane (ii) can be produced in the presence of thermoplastic polyurethane (i). The cast polyurethane (ii) is advantageously in contact over its area with (i).

A further embodiment can comprise joining thermoplastic polyurethane (i) to prefabricated noncellular cast polyurethane (ii).

For the purposes of the invention, joining over an area means that this joining is achieved by means of hotmelt adhesive bonding, solvent adhesive bonding and/or reactive adhesive bonding. Here, it is also possible to use additional adhesives. Furthermore, joining over an area can be achieved by mechanical means, e.g. by means of seam material, riveting, tackers or the like.

The adhesion measured in the form of ultimate tensile strength between the at least two components should be from at least 0.5 to 3.0 N/mm², preferably from 0.8 to 3.0 N/mm², particularly preferably from 1.5 to 3.0 N/mm².

TPU and CPU usually consist of linear polyols (macrodiols) such as polyester diols, polyether diols or polycarbonate diols, organic diisocyanates and short-chain, usually functional alcohols (chain extenders). The reaction of the starting components can be carried out by known methods such as the one-shot process or the prepolymer process.

The thermoplastic polyurethanes (TPU) and cast polyurethanes (CPU) used are reaction products of
I) organic diisocyanates
II) polyols
III) chain extenders.

As organic diisocyanates (I), it is possible to use aromatic, aliphatic, heterocyclic and cycloaliphatic diisocyanates or mixtures of these diisocyanates (cf. HOUBEN-WEYL “Methoden der organischen Chemie”, Volume E20 “Makromolekulare Stoffe”, Georg Thieme Verlag, Stuttgart, New York 1987, pp. 1587-1593, or Justus Liebigs Annalen der Chemie, 562, pages 75 to 136).

Specific examples are: aliphatic diisocyanates such as hexamethylene diisocyanate, cycloaliphatic diisocyanates such as isophorone diisocyanate, cyclohexane 1,4-diisocyanate, 1-methyl-cyclohexane 2,4-diisocyanate and 1-methylcyclohexane 2,6-diisocyanate and also the corresponding isomer mixtures, dicyciohexylmethane 4,4′-diisocyanate, dicyclohexylmethane 2,4′-diisocyanate and dicyclohexylmethane 2,2′-diisocyanate and also the corresponding isomer mixtures, aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and diphenylmethane 2,4′-diisocyanates, 4,4′-diisocyanato-1,2-diphenylethane and naphthylene 1,5-diisocyanate. Preference is given to using hexamethylene 1,6-diisocyanate, isophorone diisocyanate, dicyclohexylmethane diisocyanate, diphenylmethane diisocyanate isomer mixtures having a diphenylmethane 4,4′-diisocyanate content of >96% by weight and in particular diphenylmethane 4,4′-diisocyanate and naphthylene 1,5-diisocyanate. The diisocyanates mentioned can be employed individually or in the form of mixtures with one another. They can also be used together with up to 15% by weight (calculated on the basis of the total amount of diisocyanate) of a polyisocyanate, for example triphenylmethane 4,4′,4″-triisocyanate or polyphenylpolymethylene polyisocyanates.

As polyols (II), it is possible to use polyether diols, polyester diols, polycaprolactone diols and mixtures of the respective diols; apart from diols, it is also possible to use polyether polyols, polyester polyols, polycaprolactone polyols having a functionality of >2 and also mixtures of the respective polyols.

Suitable polyether diols can be prepared by reacting one or more alkylene oxides having from 2 to 4 carbon atoms in the alkylene radical with a starter molecule containing two active hydrogen atoms in bonded form. As alkylene oxides, mention may be made of, for example: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides can be used individually, alternatively in succession or as mixtures. Possible starter molecules are, for example: water, amino alcohols such as N-alkyldiethanolamines, for example N-methyldiethanolamine, and glycols such as ethylene glycol, 1,3-propylene glycol, 1,4-butanediol and 1,6-hexanediol. Mixtures of starter molecules can optionally also be used. Further suitable polyetherols are the hydroxyl-containing polymerization products of tetrahydrofuran. It is also possible to use trifunctional polyethers in proportions of from 0 to 30% by weight, based on the bifunctional polyethers, but at most in such an amount that a still thermoplastically processable product is formed in the case of TPU. The substantially linear polyether diols preferably have number average molecular weights n of from 500 to 10 000 g/mol, particularly preferably from 500 to 6000 g/mol. They can be employed either individually or in the form of mixtures with one another.

Suitable polyester diols can be prepared, for example, from dicarboxylic acids having from 2 to 12 carbon atoms, preferably from 4 to 6 carbon atoms, and polyhydric alcohols. Possible dicarboxylic acids are, for example: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids can be used individually or as mixtures, e.g. in the form of a succinic, glutaric and adipic acid mixture. To prepare the polyester diols, it may be advantageous to use the corresponding dicarboxylic acid derivatives such as carboxylic diesters having from 1 to 4 carbon atoms in the alcohol radical, carboxylic anhydrides or carboxylic acid chlorides instead of the dicarboxylic acids. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the polyhydric alcohols can be used either alone or in admixture with one another. Also suitable are esters of carbonic acid with the diols mentioned, in particular those having from 4 to 6 carbon atoms, e.g. 1,4-butanediol or 1,6-hexanediol, condensation products of hydroxycarboxylic acids such as hydroxycaproic acid or polymerization products of lactones, e.g. optionally substituted caprolactones. As polyester diols, preference is given to using ethanediol polyadipates, 1,4-butanediol polyadipates, ethanediol-1,4-butanediol polyadipates, 1,6-hexanediol-neopentyl glycol polyadipates, 1,6-hexanediol-1,4-butanediol polyadipates and polycaprolactones. The polyester diols have, in the case of TPU, number average molecular weights n of from 500 to 10 000 g/mol, particularly preferably from 600 to 6000 g/mol, and can be employed either individually or in the form of mixtures with one another.

The polyester diols have, in the case of CPU, number average molecular weights n of from 500 to 4000 g/mol, particularly preferably from 800 to 3000 g/mol, and can be employed either individually or in the form of mixtures with one another.

In one embodiment of the invention, the ratio of component 1 to component 11 is selected so that a small excess of NCO groups is obtained in the preparation of the TPU. The equivalence ratio of NCO groups to the total of NCO-reactive groups, in particular the OH groups of the low molecular weight diols/triols and polyols, is preferably from 0.9:1.0 to 1.2:1.0, preferably from 0.95:1.0 to 1.10:1.0.

As chain extenders (III), use is made of diols or diamines having a molecular weight of from 60 to 495 g/mol, preferably aliphatic diols having from 2 to 14 carbon atoms, e.g. ethanediol, 1,2-propanediol, 1,3-propanediol, 1,4-butanediol, 2,3-butanediol, 1,5-pentanediol, 1,6-hexanediol, diethylene glycol and dipropylene glycol. However, diesters of terephthalic acid with glycols having from 2 to 4 carbon atoms, e.g. bisethylene glycol terephthalate or bis-1,4-butanediol terephthalate, hydroxyalkylene ethers of hydroquinone, e.g. 1,4-di(hydroxyethyl)hydroquinone, ethoxylated bisphenols, e.g. 1,4-di(hydroxyethyl)bisphenol A, (cyclo)aliphatic diamines such as isophoronediamine, ethylenediamine, 1,2-propylenediamine, 1,3-propylenediamine, N-methylpropylene-1,3-diamine, N,N′-dimethylethylenediamine, and aromatic diamines such as 2,4-tolylenediamine, 2,6-tolylenediamine, 3,5-diethyl-2,4-tolylenediamine or 3,5-diethyl-2,6-tolylenediamine or primary monoalkyl-, dialkyl-, trialkyl- or tetraalkyl-substituted 4,4′-diaminodiphenylmethanes are also suitable. Particular preference is given to using ethanediol, 1,4-butanediol, 1,6-hexanediol, 1,4-di(hydroxyethyl)hydroquinone or 1,4-di(hydroxyethyl)bisphenol A as chain extenders. It is also possible to use mixtures of the abovementioned chain extenders. In addition, relatively small amounts of triols can also be added.

Compounds which are monofunctional toward isocyanates can, in the case of TPU, be used in proportions of up to from 0.0001 to 2% by weight, preferably from 0.001 to 1% by weight, based on thermoplastic polyurethane, as chain terminators or mould release agents. Suitable compounds of this type are, for example, monoamines such as butylamine and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The thermoplastic polyurethanes (TPU) and cast polyurethanes (CPU) used according to the invention can contain, as auxiliaries and additives, from 0.0001 to 20% by weight, preferably 0.001-10% by weight, particularly preferably from 0.01 to 3% by weight, based on the total amount of TPU or CPU, of the customary auxiliaries and additives. Typical auxiliaries and additives are catalysts, pigments, dyes, flame retardants, stabilizers against ageing influences and weathering influences, plasticizers, lubricants and mould release agents, fungistatic and bacteriostatic substances and also fillers and mixtures thereof.

Suitable catalysts are the customary tertiary amines known from the prior art, e.g. triethylamine, dimethylcyclohexylamine, N-methylmorpholine, N,N′-dimethylpiperazine, 2-(dimethylamino-ethoxy)ethanol, diazabicyclo[2.2.2]octane and the like, and also, in particular, organic metal compounds such as titanic esters, iron compounds or tin compounds such as tin diacetate, tin dioctoate, tin dilaurate or the dialkyltin salts of aliphatic carboxylic acids, e.g. dibutyltin diacetate or dibutyltin dilaurate or the like. Preferred catalysts are organic metal compounds, in particular titanic esters, iron compounds and tin compounds. The total amount of catalysts in the TPU or CPU is generally from about 0 to 5% by weight, preferably from 0 to 2% by weight, based on the total amount of TPU or CPU.

Examples of further additives are lubricants such as fatty acid esters, metal soaps thereof, fatty acid amides, fatty acid ester amides and silicone compounds, antiblocking agents, inhibitors, stabilizers against hydrolysis, light, heat and discoloration, flame retardants, dyes, pigments, inorganic and/or organic fillers and reinforcing materials. Reinforcing materials are, in particular, fibrous reinforcing materials such as inorganic fibres which can be produced according to the prior art and can also have been treated with a size. Further details regarding the auxiliaries and additives mentioned may be found in the specialist literature, for example the monograph by J. H. Saunders and K. C. Frisch “High Polymers”, Volume XVI, Polyurethane, Parts 1 and 2, Verlag Interscience Publishers 1962 and 1964, the Taschenbuch für Kunststoff-Additive by R. Gächter and H. Müller (Hanser Verlag, Munich 1990) or DE-A 29 01 774.

In an embodiment of the invention no reinforcing materials are comprised in the elastomer sandwiches or metal composite elements.

Further additives which can be incorporated into the TPU or CPU are thermoplastics, for example polycarbonates and acrylonitrile/butadiene/styrene terpolymers, in particular ABS. Other elastomers such as rubber, ethylene/vinyl acetate copolymers, styrene/butadiene copolymers and other types of TPU or CPU can also be used.

Commercial plasticizers such as phosphates, phthalates, adipates, sebacates and alkylsulphonic esters are also suitable for incorporation.

In one embodiment of the invention, at least either TPU or CPU does not contain any additives; particularly preferably neither TPU nor CPU contains any additives.

The TPU layer for producing the elastomer sandwich systems is used in the form of shaped bodies having large faces, e.g. plates, usually having a thickness of from 1, 5 to 25 mm, preferably from 2 to 15 mm, especially from 2 to 10 mm or from 2 to 20 mm, preferably from 2.5 to 12 mm, particularly preferably from 3 to 10 mm. The TPU layer can be produced continuously or batchwise. The best-known production processes are the belt process as described in GB-A 1 057 018 and the extruder process as described in DE-A 19 64 834.

The thermoplastic polyurethanes of the TPU layer can be prepared batchwise or continuously without addition of solvents. The TPUs according to the invention can be prepared continuously by, for example, the mixing head/belt process or the extruder process. In the extruder process, e.g. in a multiscrew extruder, the components I), II) and III) can be introduced simultaneously, i.e. in the one-shot process, or in succession, i.e. by a prepolymer process. Here, the prepolymer can either be initially charged batchwise or be produced continuously in part of the extruder or in a separate, upstream prepolymer apparatus.

According to the invention, the elastomer sandwich systems contain a TPU layer, preferably a cover layer, which has a hardness of from 75 Shore A to 95 Shore A, preferably from 80 Shore A to 90 Shore A, particularly preferably from 82 Shore A to 87 Shore A, and is a reaction product of an aliphatic diisocyanate (I), at least one Zerewitinoff-active polyol having on average from at least 1.8 to not more than 2.3 Zerewitinoff-active hydrogen atoms and having a number average molecular weight of from 500 to 5000 g/mol (II) and at least one Zerewitinoff-active polyol having on average from at least 1.8 to not more than 2.3 Zerewitinoff-active hydrogen atoms and having a number average molecular weight of from 60 to 495 g/mol as chain extender (III), where the molar ratio of the NCO groups of the aliphatic diisocyanate to the OH groups of the chain extender (III) and of the polyol (II) is from 0.9 to 1.2, preferably from 0.95 to 1.1.

Furthermore, the TPUs have a tensile strength in accordance with DIN 53504 of from 25 MPa to 100 MPa, preferably from 35 MPa to 80 MPa, particularly preferably from 40 MPa to 70 MPa.

In addition, the TPUs have an elongation at break in accordance with DIN 53512 of from 350% to 800%, preferably from 400% to 700%, particularly preferably from 500% to 650%.

The thermoplastic polyurethanes additionally display a rebound resilience in accordance with DIN 53512 of 35%-70%, preferably from 40% to 70%, particularly preferably from 50 to 65%.

The noncellular cast polyurethane layer (CPU) is produced by the known processes as described in EP-A1 2 531 538.

Possibilities for improving the adhesion between the TPU layer and the CPU layer are known methods such as sandblasting and/or degreasing of the TPU layer by means of organic solvents such as alcohols before application of the cast polyurethane.

The elastomer sandwich systems are, according to the invention, produced by production of the noncellular cast polyurethanes in the presence of the TPU layer. Noncellular cast polyurethanes and processes for producing them are generally known.

They have a density of from 800 to 1800 kg/m³, preferably from 1000 to 1500 kg/m³, particularly preferably from 1100 to 1300 kg/m³.

Furthermore, the cast polyurethanes have a tensile strength in accordance with DIN 53504 of from 25 MPa to 60 MPa, preferably from 35 MPa to 55 MPa, particularly preferably from 40 MPa to 50 MPa.

In addition, the cast polyurethanes have an elongation at break in accordance with DIN 53504 of from 300% to 800%, preferably from 400% to 700%, particularly preferably from 500% to 650%.

The cast polyurethanes additionally have a rebound resilience in accordance with DIN 53512 of 35%-70%, preferably from 40% to 70%, particularly preferably from 50 to 65%.

The noncellular cast polyurethanes can be produced by the generally known reaction of isocyanates with isocyanate-reactive compounds in the presence of catalysts and/or auxiliaries and/or additives.

To produce the noncellular cast polyurethanes, I and II+III are preferably reacted in such amounts that the ratio of NCO-reactive groups to NCO groups is preferably in the range from 0.85 to 1.25, particularly preferably in the range from 0.94 to 0.98.

According to the invention, the cast polyurethane (ii) is produced in an open or closed mould in contact with the thermoplastic polyurethane (i) by reacting a prepolymer having isocyanate groups or a modified isocyanate with a crosslinker component containing catalysts and optionally auxiliaries.

The noncellular cast polyurethanes and thus the elastomer sandwich systems of the invention are advantageously produced by the one-shot process or the prepolymer process, for example by means of the high-pressure or low-pressure technique in open or closed moulds, for example metallic moulds. The elastomer sandwich systems are preferably produced in moulds into which the TPU is placed, preferably in the form of a shaped body. The reaction of the starting components to produce the noncellular cast polyurethane elastomer is carried out in direct contact with the shaped TPU body, which can at least partly have a large face, or the TPU layer, so that a join between the two materials is produced as a result of the reaction of the starting components.

Furthermore, the treatment of the surface of the thermoplastic polyurethane (i) in order to optimize the adhesion to the cast polyurethane (ii) before the production of or joining to the cast polyurethane (ii) can, according to the invention, be effected by degreasing and/or sandblasting.

A pretreatment, in particular cleaning, of the surface of the shaped TPU body or the TPU layer can advantageously be carried out before the reaction. The interior walls of the moulds, in particular those which come into contact with the starting components for producing the noncellular cast polyurethane elastomer, can preferably be provided with a conventional mould release agent.

The starting components are usually mixed at a temperature of from 20° C. to 100° C., preferably from 30° C. to 100° C., more preferably from 40 to 85° C., and introduced into the open or closed mould. The temperature of the interior surface of the mould is advantageously from 20 to 110° C., preferably from 50 to 100° C.

In a prepolymer process, prepolymers which have isocyanate groups and are based on diphenylmethane diisocyanate (MDI) and/or carbodiimidized/uretoniminized diphenylmethane diisocyanate and/or allophanatized diphenylmethane diisocyanate or tolylene diisocyanate (TDI) are preferably used. The prepolymers having an NCO content in the range from 5 to 26%, preferably from 10 to 23%, particularly preferably from 12 to 18%, can be prepared by generally known processes, for example by reaction of a mixture containing at least one isocyanate and at least one compound which is reactive toward isocyanates, with the reaction usually being carried out at temperatures of from 35 to 100° C. If a prepolymer having isocyanate groups is to be prepared, an appropriate excess of isocyanate groups over the isocyanate-reactive groups is used for the preparation. The reaction is generally complete after from 30 to 500 minutes.

In the case of the one-shot process, the organic diisocyanates (I) are used, with preference being given to using based on diphenylmethane diisocyanate (MDI) and/or carbodiimidized/uretoniminized diphenylmethane diisocyanate and/or allophanatized diphenylmethane diisocyanate or tolylene diisocyanate (TDI).

The wall thickness of the CPU layer is generally in the range from 5 to 80 mm, from 15-80 mm, preferably from 10-60 mm, and especially preferred from 15-50 mm. The Shore A hardness of the CPU layer is in the range from 50 to 85 Shore A, preferably from 55 to 75 Shore A and particularly preferably in the range 60-70 Shore A.

The invention further provides a process for producing a metal composite element by a) producing cast polyurethane (ii) in the presence of and in contact with thermoplastic polyurethane (i) and with metal or by b) joining an elastomer sandwich system to metal. Here, the metal composite element can, for example, have the structure TPU covering layer-CPU intermediate layer-metal support. The production according to the invention of the metal composite elements can also be effected by, for example, application of the elastomer sandwich system of the invention to the metal support using a suitable adhesive system. These are preferably solvent-containing silane-containing, isocyanate-based, carboxyl-containing or organochlorine compound-containing adhesive systems. Alternative production processes include production of the CPU support layer and application of the resulting elastomer sandwich system to the metal support in a single process step, with the use of commercial adhesives advantageously being able to be dispensed with.

The invention likewise provides for the use of elastomer sandwich systems as lining elements in the transport sector, in the mining and mine sector, e.g. as a protection of the loading floors, especially loading floors of trucks, or as constituent of metal composite elements and also the use of metal composite elements as lining elements in the transport sector, in the mining and mine sector, e.g. as a protection of the loading floors, especially loading floors of trucks.

In addition, metal composite elements containing elastomer sandwich systems according to the invention are provided by the invention.

The elastomer sandwich systems and metal composite elements according to the invention can be used as an alternative to rubber-metal composite elements in hoppers or on conveyor belts in the mining sector and, owing to the excellent tear propagation resistance and the significantly lower abrasion and the significantly higher rebound resilience of the TPU covering layer compared to rubber, represent a long-life alternative. The life of the component is additionally improved by the high rebound resilience of the CPU support layer.

The invention is illustrated with the aid of the following examples, without being restricted thereto.

### EXAMPLES

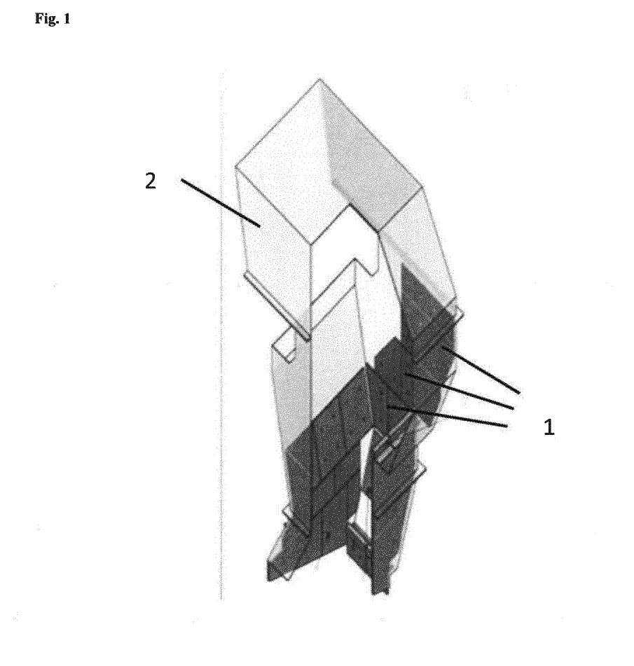

FIG. 1: shows a typical hopper in the mining and mine sector. The dark elements (1) are metal composite elements containing elastomer sandwich systems. The light-coloured elements (2) consist of metal.

FIG. 1 illustrates the use of the metal composite elements according to the invention in a typical hopper in the mining and mine sector (Siom Company, Chile). Here, the light-coloured elements (2) are the introduction elements consisting of metal, while the dark elements (1) represent the metal composite elements guiding the material to be poured. These can advantageously project into the path of the falling material to be poured in order to reduce the momentum thereof. The metal composite elements produced according to the invention are applied mechanically as protective layer to the metal interior wall of the hopper. Depending on stress caused by the impingement of stones, the wall thickness of the TPU layer and of the CPU layer are adapted appropriately.

In the case of impingement of lumps of rock up to a tonne in weight, the metal composite elements display a good protective function for the underlying metal and good resistance to abrasion and tear propagation.

### 1. Production of the TPU Layer

The formulation shown in Table 1 was reacted in a reaction extruder to give thermoplastic polyurethanes. Tests specimens for determining the mechanical properties were subsequently made from this TPU. The properties of the TPU or of the test bars are shown in Table 3. A rubber sample from Siom, Chile, which at present is used as benchmark in the mining/mine sector for hoppers and conveyor belts, was made available as reference.

Table 1 with ludication of the raw materials and composition

| | Proportion |
|---|---|
| Raw material | [% by weight] |
| 1,4-Butanediol adipate (OH number 50 mg KOH/g) | 65.70 |
| 1,4-Butanediol | 6.93 |
| 4,4′-Diphenylmethane diisocyanate | 26.64 |
| Tyzor ® AA105¹⁾ | 0.001 |
| Loxiol ® 3324²⁾ | 0.40 |
| Stabaxol ® I³⁾ | 0.26 |
| Irganox ® 1010⁴⁾ | 0.07 |

¹⁾Titanium catalyst from Dorf Ketal Chemicals India Pvt. Ltd., Mumbai
²⁾Wax from Emery Oleochemicals GmbH, Düsseldorf
³⁾Hydrolysis stabilizer from Rhein Chemie GmbH, Mannheim
⁴⁾Oxidation stabilizer from BASF SE, Ludwigshafen

### 2. Production of the CPU Layer

The formulation shown in Table 2 was reacted in an open mould to produce the cast polyurethane. Tests specimens for determining the mechanical properties were subsequently made from this CPU. The properties of the CPU or of the test bars are shown in Table 3.

Table 2 with indication of the raw materials and composition

| | Proportion |
|---|---|
| Raw material | [parts by weight] |
| Desmodur ® MDQ 24163¹⁾ | 100 |
| Baytec ® D24²⁾ | 200 |
| 1,4-Butanediol³⁾ | 8.6 |
| Catalyst SD 2.4⁴⁾ | 0.35 |

¹⁾MDI prepolymer from Covestro Elastomers SAS having an NCO content of 16.4% by weight
²⁾Polyadipate polyol from Covestro Elastomers SAS having a hydroxyl number of 56 mg KOH/g
³⁾Chain extender from BASF
⁴⁾Catalyst from Covestro Elastomers SAS

Table 3 with mechanical properties of TPU-CPU-rubber

| | | | | Rubber, | |
|---|---|---|---|---|---|
| | | | | RABERMIX | Trelleborg highly |
| | | TPU as per | CPU as per | Santiago de Chile | abrasion-resistant |
| Property | Unit | Table 1 | Table 2 | SIOM 73 | rubber plate RF 20 |
| Hardness¹ | Shore A | 87 | 65 | 78 | 65 |
| 100% modulus² | MPa | 6.3 | 2.9 | 3.2 | n.a. |
| 300% modulus³ | MPa | 14.6 | 5.8 | 11.3 | n.a. |
| Tensile strength⁴ | MPa | 57 | 43 | 14 | 24.5 |
| Tear propagation | kN/m | 70 | 24 | 68 | n.a. |
| resistance⁵ | | | | | |
| Elongation at break⁶ | % | 594 | 530 | 365 | 400 |
| Rebound resilience⁷ | % | 51 | 59 | 28 | n.a. |
| Abrasion loss⁸ | mm³ | 16 | 40 | 61 | 100 |

¹Hardness in accordance with DIN 53505
²100% modulus in accordance with DIN 53504
³300% modulus in accordance with DIN 53504
⁴Tensile strength in accordance with DIN 53504
⁵Tear propagation resistance in accordance with ISO 34-1
⁶Elongation at break in accordance with DIN 53504
⁷Rebound resilience in accordance with DIN 53512
⁸Abrasion loss in accordance with ISO 4649

Table 3 shows the advantageous properties of the TPU covering layer and the CPU support layer compared to known rubber systems. The TPU layer of the elastomer sandwich systems of the invention has a significantly improved rebound resilience and significantly lower abrasion compared to the rubber from Siom which has a similar tear propagation resistance and has been used as benchmark. Compared to an abrasion-stable rubber from Trelleborg, the tensile strength and elongation at break is improved and, in particular, the abrasion resistance is also improved.

Compared to the rubber from Siom and the abrasion-stable rubber from Trelleborg, the CPU displays an improved tensile strength, elongation at break and abrasion resistance combined with very good rebound resilience.

The abrasion loss in accordance with ISO 4649 (applicable to CPU and TPU) was calculated as follows:

Abrasion in mm³=(X−Y)/Z*K,

where

X is the mass of the test specimen before the measurement,

Y is the mass of the test specimen after the measurement,

Z is the density of the component and

K is the correction factor.

### 3. Production of the Elastomer Sandwich Systems

The elastomer sandwich elements were produced by placing the cleaned TPU layer in a mould and subsequently pouring the required raw materials (I, II and III) by hand or with machine mixing into the mould. The noncellular cast polyurethane CPU was formed in direct contact with the TPU. The mould temperature was 80° C.

A system analogous to Table 3 was used as reaction mixture for producing the noncellular cast polyurethane.

The elastomer sandwich systems produced had densities of 1200 g/cm³.

The corresponding metal composite elements were produced by applying the elastomer sandwich system to a metal support using an adhesive system.

1.-15. (canceled)

16. An elastomer sandwich systems containing at least two components, wherein one component is
(i) a thermoplastic polyurethane functioning as a cover layer and, adhering thereto over its area, the second component is
(ii) a noncellular cast polyurethane having a density of from 800 to 1800 kg/m³ functioning as a carrier layer,
wherein the at least one cover layer component of the elastomer sandwich system has a tear propagation resistance in accordance with ISO 34-1 of from 30 kN/m to 85 kN/m and an abrasion loss in accordance with ISO 4649 of from 50 mm³ to 5 mm³ and in addition at least the two components have a rebound resilience in accordance with DIN 53512 of 35%-70%.

17. The elastomer sandwich system according to claim 16, wherein it is a layer composite in which at least one thermoplastic polyurethane layer is joined to at least one noncellular cast polyurethane layer.

18. The elastomer sandwich system according to claim 16, wherein it is a thermoplastic polyurethane (i)—noncellular cast polyurethane (ii) layer composite or a thermoplastic polyurethane (i)—noncellular cast polyurethane (ii)—thermoplastic polyurethane (i) layer composite, preferably a thermoplastic polyurethane (i)—noncellular cast polyurethane (ii) layer composite.

19. The elastomer sandwich system according to claim 16, wherein the wall thickness of the noncellular cast polyurethane layer is from 5 to 80 mm.

20. A process for producing an elastomer sandwich according to claim 16 by
a) Production of thermoplastic polyurethane (i) and
b) subsequent attachment of noncellular cast polyurethane (ii).

21. The process according to claim 20 for producing noncellular cast polyurethane (ii) in the presence of thermoplastic polyurethane (i).

22. The process according to claim 20 by joining thermoplastic polyurethane (i) to prefabricated noncellular cast polyurethane (ii).

23. The process according to claim 20, wherein the noncellular cast polyurethane (ii) is produced in an open or closed mould in contact with thermoplastic polyurethane (i) by reacting a prepolymer having isocyanate groups or a modified isocyanate with a crosslinker component containing catalysts and optionally auxiliaries.

24. The process according to any of claim 21, wherein the surface of the thermoplastic polyurethane (i) is cleaned by degreasing and/or sandblasting before the production of or joining to the noncellular cast polyurethane (ii) in order to optimize the adhesion to the noncellular cast polyurethane (ii).

25. The process for producing a metal composite element by a) producing noncellular cast polyurethane (ii) in the presence of and in contact with thermoplastic polyurethane (i) and with metal or by b) joining an elastomer sandwich system according to claim 16 to metal.

26. A method comprising utilizing the elastomer sandwich systems according to claim 16 as lining elements in the transport sector, mining and mine sector or as a protection for loading floors.

27. A metal composite element containing the elastomer sandwich systems according to claim 16.

28. A method comprising utilizing the metal composite elements according to claim 27 as lining elements in the transport sector, in the mining and mine sector or as a protection for loading floors.

29. A funnel element or hopper containing metal composite elements according to claim 28.

30. A conveyor belt containing metal composite elements according to claim 28.
